(19) United States
(12) Patent Application Publication
(10) Pub. No.: US 2015/0006325 A1
(43) Pub. Date: Jan. 1, 2015

(54) PRODUCT SEARCH USING USER SELECTIONS IN IMAGES SYSTEMS AND METHODS

(71) Applicant: Lucy Ma Zhao, San Jose, CA (US)

(72) Inventor: Lucy Ma Zhao, San Jose, CA (US)

(21) Appl. No.: 13/928,932

(22) Filed: Jun. 27, 2013

(51) Int. Cl. G06Q 30/06

(52) U.S. Cl. CPC G06Q 30/0625
USPC 705/26.62

(57) ABSTRACT

Systems and methods for data a product search using user selections in images are described. The methods include receiving, from a user device, a user selection corresponding to an element in an image, wherein the element is one of a plurality of elements associated with the image, determining at least one product based on the user selection, and communicating the at least one product to the user device. The user selection may correspond to at least one of a color selection, a shape selection, a product selection, and a brand selection in the first image. The method may further include receiving additional user selections and determining additional products based on the user selections.

### BACKGROUND

1. Field of the Invention

The present application is directed towards methods and systems for executing a product search using user selection in an image and more specifically to receiving user tags of characteristics in an image and transmitting the tags to a marketplace server to be used in a search for recommended products.

2. Related Art

During an average day, consumers may be view a variety of products and/or content that they find desirable. For example, a consumer may flip through a magazine and find a color of a particular item, such as nail polish, as particularly desirable. Additionally, the consumer may view products on display in store windows that they would like to purchase. The consumer may further see brands that they would like to research or view additional brand products. However, the consumer may not wish to purchase the product at the time due to financial concerns. However, without writing down each interest, the consumer may easily forget the interest before searching for similar products.

Even if a consumer manually writes down the interest, the consumer may be prone to forget the exact characteristics of the interest. While photographs can help, the photographs may not help the consumer find the exact product. For example, the consumer may not know the name of a color used in the image or may not know the style or designer of a product. Moreover, the consumer might not be able to view products similar to a variety of interests at once. Thus, a need exists for systems and methods that search products using user selections in images.

### BRIEF DESCRIPTION OF THE FIGURES

FIG. 1 is a block diagram of a networked system suitable for implementing the methods described herein according to an embodiment;

FIG. 2 is a flowchart showing a method of transmission of user selections to a server to execute a search corresponding to the user selections;

FIG. 3 is a flowchart showing a method of reception of user selections by a server and execution of a search corresponding to the user selections;

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for a product search using user selections in an image. A user device may take or possess images having various elements, such as colors, products, brands, or other user interests. A user possessing the user device may import and/or view the images in a tagging application, where the user can tag or otherwise select elements the user is interested in. The user selections may then be uploaded to a server, which may contain a server marketplace. The server may analyze the user selections, and in some embodiments, the image, to obtain search terms. Using the search terms, the server may execute a corresponding search to find products related to one or more elements of interest from other products. The search may include the search terms corresponding to the tag or tags for just one image. However, in other embodiments, the search terms may further utilize past saved images, user selections, and/or search terms from a user profile. Once search results have been collected, the search results may be transmitted back to the user device. The user device may display the search results to the user including URLs and/or hyperlinks to purchase the related products. If the user selects the product, the user may be presented with the product on the server marketplace and/or other online retail server. Additionally, the user may be presented with a payment option using a payment service provider.

In one embodiment, a user may browse a magazine and view a specific color of a nail polish the user likes. The user may take an image of the nail polish using a user device camera. The user may utilize a tagging application to take the image, or may import the image from a separate application. Once the image is viewable within the tagging application, the user may tag or otherwise select the nail polish color with a category tag corresponding to “color.” Later, the user may view a dress in a store window; however, the user may dislike the color or not want to purchase the dress at the time. The user may take another image and, using the tagging application, tag the dress in the image under the category “shape” or “product.” Later, the user may receive a “product match” notice from a search server. The notice may include products corresponding to the color and shape/product tagged in the two images. Thus, the user may be able to select and purchase the products, such as on a marketplace server or other online retail server Ebay®, Inc. of San Jose, Calif.. Additionally, the application may provide an interface or link to a corresponding payment service provider and PayPal®, Inc. of San Jose, CA in order to pay for the products.

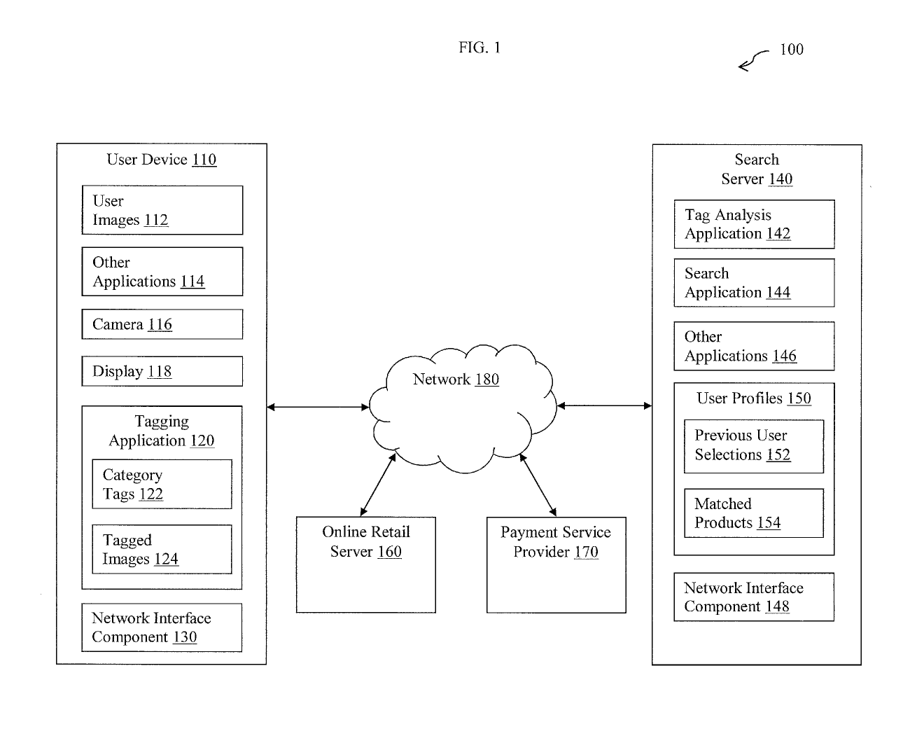

FIG. 1 illustrates an exemplary embodiment of a system environment 100 for implementing one or more processes described herein over a network 180. As shown, system environment 100 may comprise or implement a plurality of devices, servers, and/or software components that operate to perform various methodologies in accordance with the described embodiments. Exemplary devices and servers may include, for example, devices, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

As shown in FIG. 1, system environment 100 includes a user device 110, a search server 140, an online retail server 160, and a payment service provider 170 in communication over network 180. A user may utilize user device 110 to take photographs, download images, and tag interests in the photographs and/or images as user selections. Those user selections may be transmitted to search server 140 for analysis and execution of a search corresponding to the user selections. The search may include online retail server 160, for example an online retailer and/or marketplace server. Results from the search may be transmitted back to user device 110 for display to the user. If the user decides to purchase a product from the results, the user may be connected to online retail server 160 to provide payment service between the user and online retail server 160.

User device 110, search server 140, online retailer 160, and payment service provider 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system environment 100, and/or accessible over network 180.

User device 110 may correspond to an interactive device for image tagging and data transmission, such as a personal computer or system of networked computers, PDA, mobile cellular phone, tablet computer, or other device. User device 110 may be implemented using any appropriate hardware and software configured for wired and/or wireless communication over network 180. Although a user device is shown, the user device may be managed or controlled by any suitable processing device. Although only one user device is shown, a plurality of user devices may be utilized.

User device 110 is shown with user images 112, other applications 114, a camera 116, a display 118, a tagging application 120, and a network interface component 130. User images 112 may correspond to images, pictures, digital images, or other images stored on user device 110. User images 112 may be taken by a user of user device 110 using camera 116. However, in other embodiments, user images 112 may also include images received over network 180 or otherwise stored to user device 110, for example, using a connectable external storage unit containing images, such as a USB Flash drive or external hard drive. User images 112 may include elements of interest to a user, such as specific colors, shapes, designs, brands, products, or other interests. In another embodiment, the images may be stored in a cloud, server, or other location outside user device 110.

Other applications 114 and tagging application 120 may correspond to processes, procedures, and/or applications executable by a hardware processor, for example, a software program. In one embodiment, other applications 114 contain software programs, such as a graphical user interface (GUI), executable by a processor that is configured to interface and communicate with the one or more users and/or servers, client devices, search server 140, online retail server 160, and/or payment service provider 170 via the network 180. The GUI enables the entities to access and communicate with user device 110, for example to receive input, search results, product purchase pages, payment services, or other information. Other applications 114 may include further applications necessary for the described functions of user device 110. Thus, in various embodiments, other applications 114 may provide additional features to a user of user device 160. For example, these other applications 114 may include security applications for implementing client-side security features, programmatic client applications for interfacing with appropriate application programming interfaces (APIs) over the network 180 or various other types of generally known programs and/or applications.

User device 110 of FIG. 1 is shown with camera 116. Camera 116 may correspond to an optical instrument usable to capture photographs by a user. Camera 116 may capture still images and/or video images. Camera 116 may be usable with a separate application of user device 110 and/or may be usable with tagging application 120 to capture images.

User device 110 includes display 118. Display 118 may correspond to a display usable by a processor of user device 110 for use with rendering and displaying applications and associated data. In certain embodiments, display 118 may be utilized to display images, search results, webpages, product purchase information, payment service information, and/or other information. Display 118 may be implemented as a liquid-crystal display, plasma display panel, cathode ray tube, or other display.

In various embodiments, tagging application 120 includes category tags 122 and tagged images 124. Tagging application 120 may correspond to a software program, process, or procedure allows a user of user device 110 to select, “tag,” or otherwise indicate elements of interest to a user in an image and why that element is of interest. For example, tagging application 129 may enable a user to import an image, such as user images 112, or may allow a user to utilize tagging application 120 to capture an image. While viewing the image in tagging application 120, the user may select one or more elements corresponding to the image. The user may choose a category from category tags 122 when selecting the element. Category tags 122 may correspond to categories of interest, for example, color, shape, product, design, size, price, or brand. However, such a list is not exhaustive, and other categories of user interests may be used. Once the user has tagged or otherwise made at least one user selection in an image, the image may be stored as tagged images 124. Either at specific intervals or on a user command, tagged images 124, and/or user selections may be uploaded to search server 140 for analysis and search.

User device 110, in various embodiments, may include at least one network interface component (NIC) 130 adapted to communicate with network 180 including search server 140, online retail server 160, and/or payment service provider 170. In various embodiments, network interface component 130 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Search server 140 may be maintained by a search engine provider, for example a website containing a search engine usable by a user. In this regard, search server 140 may provide a search engine and/or application, such as search application 144. However, in other embodiments, search server 140 may correspond to a service provider such as Ebay®, Inc. of San Jose, Calif. utilizing a local search means. Furthermore, in various embodiments, search server 140 may correspond to any appropriate search device, such as a personal computer or system of networked computers, personal digital assistant (PDA), mobile cellular phone, tablet computer, or other device. Although only one server is shown, a plurality of servers may be utilized.

Search server of FIG. 1 is shown with a tag analysis application 142, a search application 144, other application 146, user profiles 150, and a network interface component 148. In various embodiments, tag analysis application 142 may correspond to an application for analysis of uploaded images and associated user selections, or “tags.” As previously discussed, the user selections may correspond to interests in an image. The user selections may include a category from category tags 122. Using tag analysis application 142, search server 140 may determine the user interest indicated by the user selection. For example, if a user has selected a color in an image and tagged the selection with a “color” category tag, tag analysis application 142 may determine the color indicated. Similarly, if the user has tagged an object or product with a “shape” or “product” tag, tag analysis application 142 may determine an associated shape or product, for example a type of dress. Thus, tag analysis application 142 may determine at least one search term from user selections in the image.

Search application 144 may correspond to a search engine or other search process usable with search terms determined from user selections in an image. Search application 144 may receive the search terms from tag analysis application 142 and may execute a search using the search terms. In one embodiment, search application 144 may perform a local search, for example if search server 140 further includes, or is local to, online retail server 160. In such an example, search server and online retail server 160 may correspond to services provided by Ebay®, Inc. of San Jose, Calif. However, in other embodiments, search server 140 may utilize search application 144 to perform a search over network 180 using, for example, external online retailers and/or marketplace servers, such as online retail server 160 of FIG. 1 accessible over network 180.

In various embodiments, other applications 146 provide desirable features to search server 140 and/or a user. For example, other applications 146 may contain software programs, such as a graphical user interface (GUI), executable by a processor that is configured to interface and communicate with the one or more client/user devices, such as user device 110, via the network 180. The GUI enables the client/user devices to access and communicate with search server 140, for example to access and utilize tag analysis application 142, search application 144, database 150, and/or corresponding processes. Other applications 146 may include further applications necessary for the described functions of search server 140. Thus, in various embodiments, other applications 146 may provide additional features for search server 140. For example, these other applications 146 may include security applications for implementing server-side security features, programmatic client applications for interfacing with appropriate application programming interfaces (APIs) over the network 180 or various other types of generally known programs and/or applications.

User profiles 150 containing previous user selections 152 and matched products 154 may correspond to data stored in a database as required by certain embodiments. User profiles 150 may correspond to profile data established by a user of user device 110 when using tagging application 120. The user may enter user information to search server 140 or the information may be taken from previously stored information on user device 110. User profiles 150 may further include stored data corresponding to each user profile in user profiles 150, for example previous user selections 152 and matched products 154. Previous user selections 152 may correspond to user selections stored from previous images and corresponding data. For example, a user may indicate a specific color from a magazine the user finds desirable. The color may be stored as previous user selections 152 and associated with the corresponding account in user accounts 150. Data resulting for analysis using tagging analysis application 142 may be stored with the user selections. Multiple user selections and corresponding data may be stored as previous user selections 152 for use with search application 144. Thus, search application 144 may use previous user selections 152 to find matching or similar products.

Additionally, matched products 154 may be stored and associated with a corresponding user account in user accounts 150. Matched products 154 may correspond to matched products prior to transmission to user device 110 for display to a user. Additionally, matched products 154 may include products saved by the user or stored based on user actions. For example, a user may be interested in a product from a search result by search application 144. However, the user may wish to purchase it in the future, or wait for a more appealing size, color, or other characteristic. Thus, the user may save the product. In other embodiments, the user may purchase a product, and search server 140 may choose to store the product to find similar or corresponding items, such as accessories, the user may find desirable.

Search server 140, in various embodiments, may include at least one network interface component (NIC) 148 adapted to communicate with network 180 including user device 110, online retail server 160, and/or payment service provider 170. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Online retail server 160 may be maintained, for example, by a merchant or seller offering various items, products, and/or services through an online site or application. Thus, online retail server 160 may correspond to an external online retailer from search server 140. In such embodiments, online retail server 140 may correspond to one or a plurality of online retailers. However, as previously discussed, online retail server 160 may be local to or incorporated within search server 140, for example, Ebay®, Inc. of San Jose, Calif. Generally, online retail server 160 may be maintained by anyone or any entity that receives money, which includes charities as well as retailers and restaurants. In this regard, online retail server 160 may include marketplace/browser applications, which may be configured to interact with user device 110 and/or service providers to facilitate the sale of products, goods, and/or services. Online retail server 160 may include purchasable products and/or a purchasable product database. Additionally, online retail server 160 may include payment and checkout applications to facilitate the exchange of money. However, in other embodiments, online retail server 160 may utilize an external payment service provider, such as payment service provider 170.

Payment service provider 170 may be maintained, for example, by an online payment service provider, which may provide processing for online financial and information transactions on behalf of a user with a merchant, such as online retail server 160. In this regard, payment service provider 170 includes one or more processing applications which may be configured to interact with a user device over network 180 to facilitate sending payments from a user to the merchant. In one example, payment service provider 170 may be provided by PayPal®, Inc. of San Jose, Calif., USA.

Network 180 may be implemented as a single network or a combination of multiple networks. For example, in various embodiments, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by user device 110, search server 140, online retail server 160, and payment service provider 170.

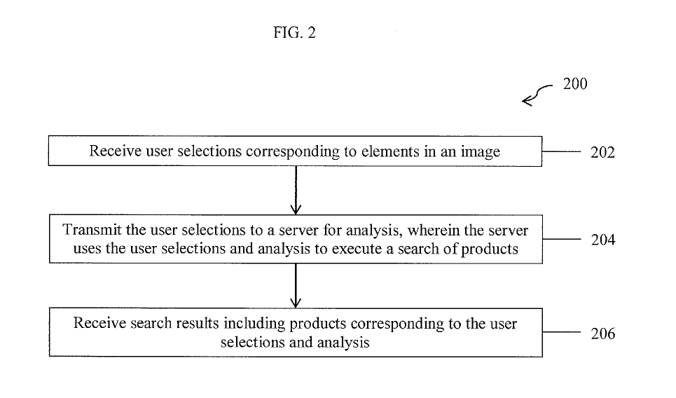

Referring now to FIG. 2, FIG. 2 is a flowchart showing a method of transmission of user selections to a server to execute a search corresponding to the user selections according to one embodiment. At step 202, a user device receives user selections corresponding to elements in an image. User device 110 may receive user input corresponding to user selections in an image, such as user images 112. A user may utilize a touch screen or accessory, such as a mouse, stylus, or other device, to select interests in the image. During or after the selection of the interest, the user may tag the interest with a category of category tags 122. If there is no suitable category, the user may create a new category, such as by typing in a category name After receiving user selections corresponding to elements of interest, the resulting image with the user selections may be stored as tagged images 124.

At step 204, at least the user selections are transmitted to a server for analysis, where the server uses the user selections and analysis to execute a search for products. Search server 140 may receive a tagged image including user selections, or only the user selections, from tagged images 124 of user device 110. After receiving the user selections, search server 140 may utilize tag analysis application 142 to determine user interests, and thus search terms.

Search server 140 may perform a search using at least one search term determined from user selections in at least one image. For example, search server 140 may utilize search application 144 to search using a user selection corresponding to a color or dress design in an image. However, in some embodiments, multiple category tags may be used in an image and/or multiple search terms determined from the user selections. Thus, search server 140 may utilize search application 144 to perform a more complex search and/or filter search results based on user selections.

Additionally, search server 140 may contain user profiles 150 having previous user selections 152 and/or purchases. Search server 140 may utilize previous user selections 152 and/or purchases with search application 144. Search application 144 may also use information obtained from previous searches presented to the user. For example, if the user ignored a presented item or indicated that the user was not interested in the item, this information may be used as a factor for not presenting the user with similar items again. Further, pervious user selections that are more current may be given more weight or importance than user selections from farther in the past. User selections and/or search terms determined from the user selections may be stored as previous user selections 152. When new user selections are received, previous user selections 152 may be utilized with the received user selections in order to find more specific products of interest to a user. Additionally, in some embodiments, search server 140 may be configured to use previous user selections 152 to present products at future time intervals, for example, if the first search is incomplete or the user does not find anything of interest.

Search application 140 may search using user selections in ways not immediately apparent to a user. For example, a user may have taken a picture of a location, such as Paris, and tagged the location or an interest point in the location as a user selection. The user may immediately receive search results for the location, such as travel and lodging information. However, the user selections in the image may also be utilized with previous user selections 152 that the user may not immediately connect. Using the previous example, “high quality coffee table books” may be a previous user selection/search term contained in previous user selections 152. Search application 140 may then combine the search term for the location, “Paris” in this example, with “high quality coffee table books” in previous user selections 152 to provide the user search results for items of user interest the user may normally overlook.

Search server 140 may utilize search application 144 with online retail server 160. As previously discussed, in some embodiments, search server 140 and online retail server 160 may correspond to the same entity, such as Ebay®, Inc. of San Jose, Calif., USA. However, in other embodiments, search server 140 may search one or a plurality of online retailers external to search server 140.

User device 110 receives search results including products corresponding to the user selections and analysis at step 206. Search server 140 may transmit results from search application 144 after running a search using search terms from received user selections and/or previous user selections 152. Search server may save search results as matched products 154. Matched products 154 may be transmitted to user device 110 for viewing by a user. Additionally, product matches designated by a user may be stored as matched products 154 and recalled by the user.

After user device 110 receives and displays the search results to a user, the user may select products among the search results for viewing or purchase. Selection of the products may include selection of a URL or embedded hyperlink connecting the user to a product purchase option corresponding to online retail server 160. Thus, in various embodiments, user device may be directed to a corresponding webpage selling the product. In other embodiments, user device 110 may utilize tagging application 120 to view and interact with the search results. For example, tagging application 120 may enable the user to purchase products from the search results.

In some embodiments, while purchasing products from the search results, user device 110 may direct the user to payment service provider 170 in order to provide payment. For example, the search results may further contain a URL or embedded hyperlink to payment service provider 170, or a product purchase page may direct the user to payment service provider 170. In other embodiments, tagging application 120 may provide payment processes by utilizing payment services of payment service provider 170 in order to pay for products.

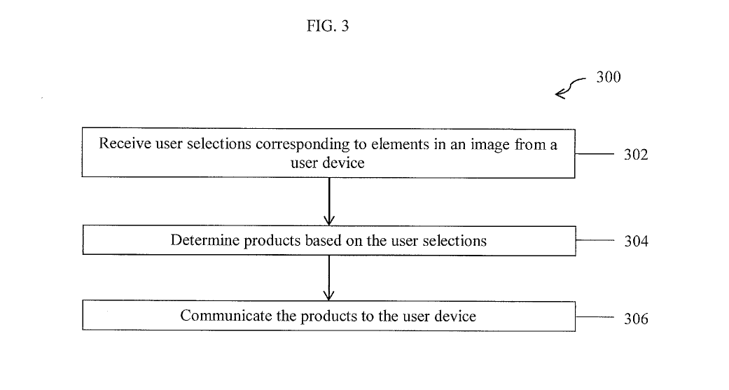

FIG. 3 is a flowchart showing a method for receiving user selections by a server and execution of a search corresponding to the user selections. Search server 140 may receive user selections corresponding to elements in an image from a user device at step 302. User device 110 may transmit user selections, including tagged images 124 in certain embodiments, to search server 140. The user selections may correspond to elements in the image the user finds desirable or interesting. Once the user had made the user selection of elements using category tags 122 or a newly created user tag, the user selections may be transmitted to search server 140.

Search server 140 may analyze the user selections to obtain search terms. After receiving the user selections, search server 140 may utilize tag analysis application 142 to analyze user selections of elements in an image. Tag analysis application 142 may include analysis of the category from category tags 122 used to tag the element, the characteristics of the element, characteristics of the image, or other information. Tag analysis application 142 may use additional data, such as location, time, user preference, or other data. After analysis of the user selections, tag analysis application 142 may determine one or more search terms from the user selections.

Once the search terms have been determined, search server 140 may determine products based on the user selections step 304. Search server 140 may execute a search for products using search application 144. Search server may search external online retailers, such as online retail server 160 over network 180. However, in other embodiments where search server 140 contains or is local to online retail server 160, search server 140 may conduct a search of local databases containing products and/or product purchase data.

The search may attempt to locate products similar to or matching at least one of the user selections. For example, if a dress shape/style is chosen, similar or matching dresses may be searched. Additionally, if more than one user selection is used, such as color and dress shape/style, the search may attempt to locate dresses in the same or similar color.

After receiving search results, search server 140 may communicate the products to a user device at step 306. User device 110 may display the search results to a user. As previously discussed, the user may then select the products for viewing, purchase, or storage. Thus, the user may view products matching the user's interests in one or more images. This enables the service provider to present more relevant products for purchase because different interests (features) of different products/content can be used in combination to find one or more products having the different features. For example, even though a user may tag a dress, the user may not like all features of the dress, so the user would not want to see similar dresses. Instead, the user may be only interested in the color of the dress. Combined with a user interest in a brand name of a shoe and a shape of vase, the user may be presented with a vase of similar shape and color of the dress from the specific brand name of the shoe.

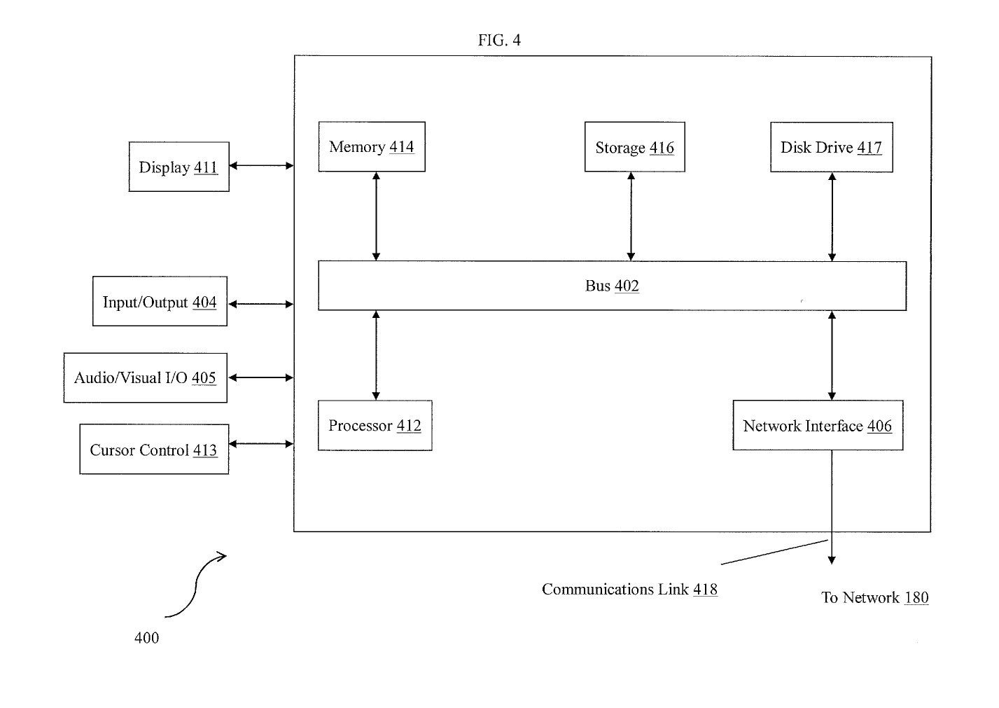

Moving to FIG. 4, FIG. 4 is a block diagram of a computer system 400 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The payment provider may utilize a network computing device (e.g., a network server) capable of communicating with the network. It should be appreciated that each of the devices utilized by users and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 180. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a memory storing machine readable instructions; and
one or more hardware processors in communication with the memory and configured to execute the instructions to:
receive, from a user device, a first user selection corresponding to a first element in a first image, wherein the first element is one of a first plurality of elements associated with the first image;
receive a category selection corresponding to the first element in the first image;
determine at least one product based on the first user selection and the category selection; and
communicate the at least one product to the user device.

2. The system of claim 1, wherein the first user selection corresponds to at least one of a color selection, a shape selection, a product selection, and a brand selection in the first image.

3. The system of claim 1, wherein the one or more hardware processors are further configured to execute the instructions to:
receive, from the user device, a second user selection corresponding to a second element in a second image, wherein the second element in the second image is one of a second plurality of elements associated with the second image.

4. The system of claim 3, wherein the one or more hardware processors are configured to execute the instructions to further determine the at least one

5. The system of claim 1, wherein the one or more hardware processors are further configured to execute the instructions to:
receive a purchase command corresponding to the at least one product.

6. The system of claim 5, wherein the one or more hardware processors are further configured to execute the instructions to:
process payment based on the purchase command.

7. The system of claim 1, wherein the first image is obtained from a camera on the user device.

8. A non-transitory machine-readable medium comprising a plurality of machine-readable instructions which when executed by one or more processors of an encoding device are adapted to cause the one or more processors to perform a method comprising:
receiving, from a user device, a first user selection corresponding to a first element in a first image, wherein the first element is one of a first plurality of elements associated with the first image;
receiving a category selection corresponding to the first element in the first image;
determining at least one product based on the first user selection and the category selection; and
communicating the at least one product to the user device.

9. The non-transitory machine readable medium of claim 8, wherein the first user selection corresponds to at least one of a color selection, a shape selection, a product selection, and a brand selection in the first image.

10. The non-transitory machine readable medium of claim 8,
receiving, from the user device, a second user selection corresponding to a second element in a second image, wherein the second element in the second image is one of a second plurality of elements associated with the second image.

11. The non-transitory machine readable medium of claim 10, wherein the determining the at least one product based on the first user selection further includes the second user selection.

12. The non-transitory machine readable medium of claim 8, wherein the method further comprises:
receiving a purchase command corresponding to the at least one product.

13. The non-transitory machine readable medium of claim 12, wherein the method further comprises:
processing payment based on the purchase command.

14. The non-transitory machine readable medium of claim 13, wherein the first image is obtained from a camera on the user device.

15. A method for use by a server, the method comprising:
receiving, from a user device, a first user selection corresponding to a first element in a first image, wherein the first element is one of a first plurality of elements associated with the first image;
receiving a category selection corresponding to the first element in the first image;
determining, using a hardware processor of the server, at least one product based on the first user selection and the category selection; and
communicating the at least one product to the user device.

16. The method of claim 15, wherein the first user selection corresponds to at least one of a color selection, a shape selection, a product selection, and a brand selection in the first image.

17. The method of claim 15 further comprising:
receiving, from the user device, a second user selection corresponding to a second element in a second image, wherein the second element in the second image is one of a second plurality of elements associated with the second image.

18. The method of claim 17, wherein the determining the at least one product based on the first user selection further includes the second user selection,

19. The method of claim 15 further comprising:
receiving a purchase command corresponding to the at least one product.

20. The method of claim 17 further comprising:
processing payment based on the purchase command.
